(19) United States
(12) Patent Application Publication
(10) Pub. No.: US 2023/0099333 A1
(43) Pub. Date: Mar. 30, 2023

(54) PHYSICAL OVERLAY INSTRUMENTS FOR FORMS

(71) Applicant: Wells Fargo Bank, N.A., San Francisco, CA (US)

(72) Inventors: Teresa Ridge, Alamo, CA (US); Terra Powers, Oakland, CA (US)

(21) Appl. No.: 16/716,121

(22) Filed: Dec. 16, 2019

(51) Int. Cl. G06Q 40/00; G06F 40/174

(52) U.S. Cl. CPC G06Q 40/123; G06F 40/174

(57) ABSTRACT

A physical overlay instrument is described that is manufactured for use with a particular form, such as a specific version of a tax form. The overlay instrument comprises a sheet of material including transparent regions and opaque regions positioned such that when the overlay instrument is placed over the particular form filled out by a user, a first set of personal information of the user included on the form is visible through the transparent regions while as second set of personal information of the user included on the form is obscured by the opaque regions. In addition, the opaque regions include one or more prompts to gather additional information from the user based on the first set of the personal information of the user that is visible through the transparent regions. The overlay instrument is manufactured from a single sheet of material and may be one-sided or two-sided.

### TECHNICAL FIELD

The disclosure relates to physical overlay instruments and methods of manufacturing the same.

### BACKGROUND

Wealth management advisors and other financial advisors may provide guidance directed to their clients' investment plan including retirement investments, trust funds and estate plans, cash flow and liquidity sources, credit needs, and tax-efficient financial strategies. In order to provide sound guidance, however, the advisors must collect a large amount of personal information from their clients. The process of collecting all of the required information can be a tedious process for both the advisors and the clients. Once the advisors have collected all of the required information from their clients, the advisors perform a complex analysis of the information in order to provide accurate and personally tailored advice to their clients.

### SUMMARY

In general, this disclosure describes a physical overlay instrument manufactured for use with a particular form. In some examples, the particular form may be a specific version of a tax form, such as a 1040, authored by the United States Internal Revenue Service (IRS) or another financial document that requests personal information of a user including financial information. The overlay instrument may be used to guide a third party, such as a wealth management advisor or another financial advisor, in collecting personal information of the user in order to provide wealth management services to the user without requiring a lengthy information gathering process. More specifically, the overlay instrument, in some cases used in conjunction with a digital overlay user guide, may assist the advisor by highlighting a portion of the personal information included on the particular form that has already been filled out by the user and prompting the advisor to gather additional information from the user based at least on the highlighted portion. In this way, the advisor may collect the required information used to perform a complex analysis and provide accurate and personally tailored advice to the user more easily and efficiently than conventional information gathering processes.

The overlay instrument comprises a sheet of material including transparent regions and opaque regions positioned such that when the overlay instrument is placed over the particular form filled out by a user, a first set of personal information of the user included on the form is visible through the transparent regions while as second set of personal information of the user included on the form is obscured by the opaque regions. In addition, the opaque regions include one or more prompts to gather additional information from the user based on the first set of the personal information of the user that is visible through the transparent regions. The overlay instrument is manufactured from a single sheet of material and may be one-sided or two-sided. The single sheet of material has dimensions substantially similar to the particular form for which the overlay is manufactured. The single sheet of material may comprise a flexible plastic film, a rigid plastic sheet, a laminated sheet of paper or card stock, or another type of material capable of being used repeatedly.

In one example, this disclosure is directed to a physical overlay instrument comprising a sheet of material having dimensions substantially similar to a particular form, wherein the particular form includes one or more queries that, when filled out by a user, include personal information of the user; one or more transparent regions defined on the sheet of material such that, when the physical overlay instrument is placed over the particular form, a first set of the personal information of the user is visible through the transparent regions; and one or more opaque regions defined on the sheet of material, wherein the opaque regions include one or more prompts for a third-party to gather additional information from the user based on the first set of the personal information of the user that is visible through the transparent regions, and wherein, when the physical overlay instrument is placed over the particular form, the opaque regions obscure a second set of the personal information of the user from the third-party.

In another example, this disclosure is directed to a method of manufacturing a physical overlay instrument comprising determining positions of one or more queries included on a particular form, wherein, when filled out by a user, the one or more queries include personal information of the user; generating, by a computing device, a digital overlay template based on the positions of the one or more queries on the particular form; receiving, by a printing device, as sheet of material having dimensions substantially similar to the particular form; defining, by the printing device and based on the digital overlay template, one or more transparent regions on the sheet of material such that, when the physical overlay instrument is placed over the particular form, a first set of the personal information of the user is visible through the transparent regions; and defining, by the printing device and based on the digital overlay template, one or more opaque regions on the sheet of material, wherein the opaque regions include one or more prompts for a third-party to gather additional information from the user based on the first set of the personal information of the user that is visible through the transparent regions and wherein, when the physical overlay instrument is placed over the particular form, the opaque regions obscure a second set of the personal information of the user from the third-party.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that includes a physical overlay instrument for a particular form and one or more devices for manufacturing the physical overlay instrument, in accordance with the techniques of this disclosure.

FIGS. 2A-2C are conceptual diagrams illustrating an example of a one-sided physical overlay instrument for a particular form, in accordance with the techniques of this disclosure.

FIGS. 3A-3C are conceptual diagrams illustrating another example of a one-sided physical overlay instrument for a particular form, in accordance with the techniques of this disclosure.

FIGS. 4A-4D are conceptual illustrating an example of a two-sided physical overlay instrument for a particular form, in accordance with the techniques of this disclosure.

FIG. 5 is a block diagram illustrating an example advisor device configured to access an overlay user guide for use in conjunction with the physical overlay instrument, in accordance with the techniques of this disclosure.

FIG. 6 is a block diagram illustrating an example computing device configured to generate an overlay template used by a printing device to manufacture the physical overlay instrument, in accordance with the techniques of this disclosure.

FIG. 7 is a flowchart illustrating an example method of manufacturing a physical overlay instrument, in accordance with the techniques of this disclosure.

### DETAILED DESCRIPTION

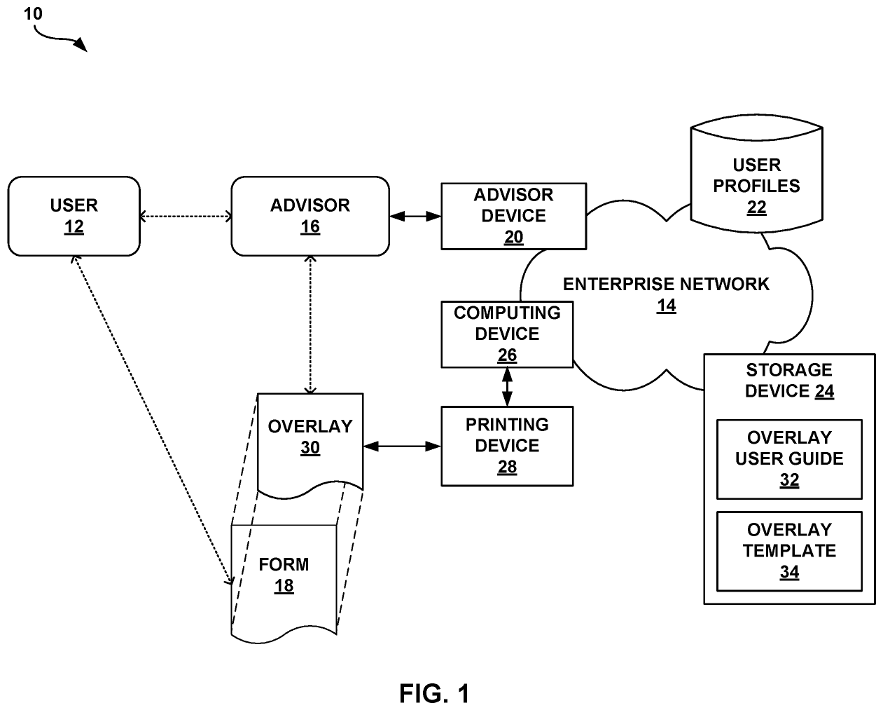

FIG. 1 is a block diagram illustrating an example system 10 that includes a physical overlay instrument 30 for a particular form 18 and one or more devices 26, 28 for manufacturing the physical overlay instrument, in accordance with the techniques of this disclosure. System 10 comprises a wealth management system through which a user 12 may receive wealth management services from advisor 16 associated with a financial institution, such as a bank, lending institution, or investment management company. Physical overlay instrument 30 may be used to guide a third party, i.e., advisor 16 in the example of FIG. 1, in collecting personal information of user 12 in order to provide the wealth management services to user 12 without requiring user 12 to go through a lengthy information gathering process. More specifically, overlay instrument 30, in some cases used in conjunction with a digital overlay user guide 34, may assist advisor 16 by highlighting a portion of the personal information included on particular form 18 that has already been filled out by user 12 and prompting advisor 16 to gather additional information from user 12 based at least on the highlighted portion. In this way, the advisor 16 may collect the required information used to perform a complex analysis and provide accurate and personally tailored advice to user 12 more easily and efficiently than conventional information gathering processes.

As shown in FIG. 1, the financial institution comprises a plurality of computing devices, e.g., advisor device 20, user profiles database 22, storage device 24, and computing device 26, communicatively coupled via enterprise network 14. Enterprise network 14 may comprise one or more wired and/or wireless communication networks, such that advisor device 20, user profiles database 22, storage device 24, and computing device 26 may communicate with one another via one or more wired and/or wireless connections.

In the example of FIG. 1, enterprise network 14 may comprise a private network associated with the financial institution. Enterprise network 14 may comprise a centralized or distributed system of computing devices, such as desktop computers, laptops, workstations, wireless devices, network-ready appliances, file servers, print servers, or other devices, such as advisor device 20 and computing device 26. For example, enterprise network 14 may include a plurality of databases, data centers, and other storage facilities, such as user profiles database 22 and storage device 24. Enterprise network 14 may be part of or connected to a public network, such as the Internet, in order to communicate with external computing devices, such as printing device 28. In some examples, enterprise network 14 may comprise one or more of a wide area network (WAN), a local area network (LAN), a virtual private network (VPN), or another wired or wireless communication network.

Advisor device 20, user profiles database 22, storage device 24, and computing device 26 may be physically located at one geographical location or may be distributed among different geographical locations. For example, advisor device 20 may comprise a computing device or terminal located at a physical office or branch location of the financial institution for use by advisor 16. Advisor 16 may use advisor device 20 while conducting wealth management conversations with user 12 based on overlay instrument 30 in order to also access digital overlay user guide 32 stored in storage device 24. Advisor device 20 may be implemented as any suitable computing system, such as one or more server computers, workstations, mainframes, appliances, cloud computing systems, and/or other computing systems that may be capable of performing operations and/or functions described in accordance with one or more aspects of the present disclosure. Advisor device 20 may communicate with user profiles database 22 and storage device 24, each of which may be located at a different geographical location than advisor device 20.

Computing device 26 may comprise a computing device located at a physical office of the financial institution that may be the same or a different location than advisor device 20. Computing device 26 may be configured to generate digital overlay template 34 stored in storage device 24 based on the particular form 18, and send instructions to printing device 28 to manufacture physical overlay instrument 30 based on overlay template 34. Computing device 26 may be implemented as any suitable computing system, such as one or more server computers, workstations, mainframes, appliances, cloud computing systems, and/or other computing systems that may be capable of performing operations and/or functions described in accordance with one or more aspects of the present disclosure. Computing device 26 may communicate with storage device 24 and printing device 28, each of which may be located at a different geographical location than computing device 26.

As described in this disclosure, physical overlay instrument 30 is manufactured for use with a particular form 18. In some examples, form 18 may be a specific version of a tax form, such as a 1040 authored by the United States Internal Revenue Service (IRS), or another financial document that requests personal information of a user including financial information. In general, tax returns provide a broad picture of a client's overall financial situation, and enable advisors to identify the client's needs for wealth planning and asset management. Overlay instrument 30 may be especially useful for advisor 16 to use with a user 12 that is looking to maximize their current income from their financial portfolios and retirement plans, diversify their portfolio by acquisition of non-financial assets, engage in business exit planning, use credit strategically to implement their financial plan, and/or protect assets by exploring long-term care, estate tax liquidity funding, and risk management solutions. In addition, overlay instrument 30 may assist advisor 16 to facilitate a review of the complex information provided on form 18 filled out by user 12 and help user 12 identify often missed area on their tax return.

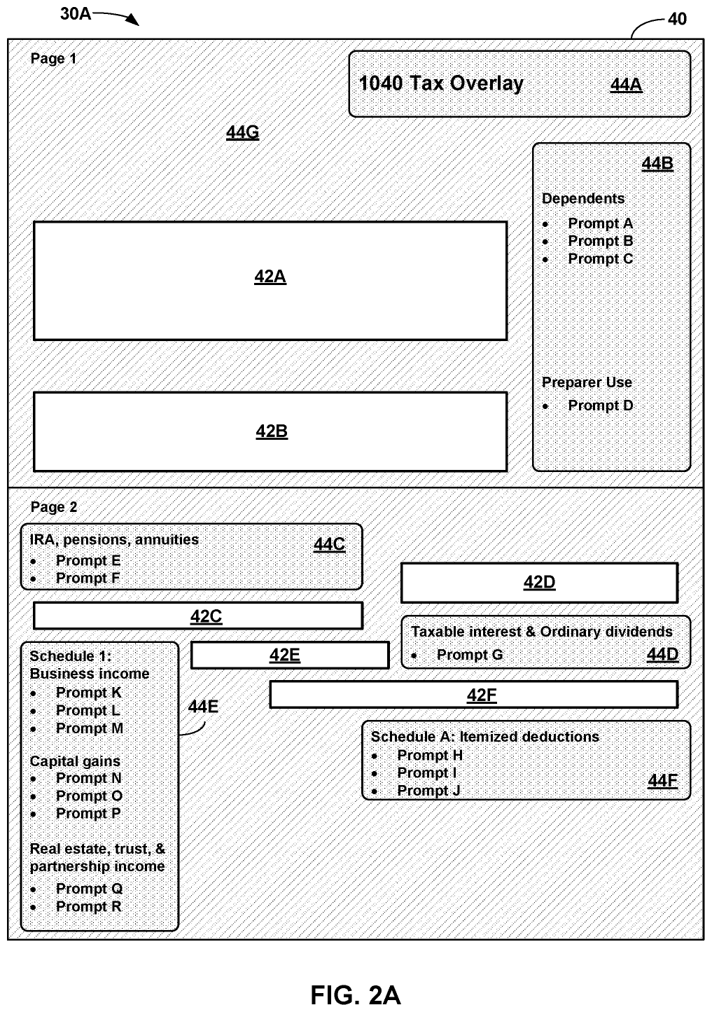

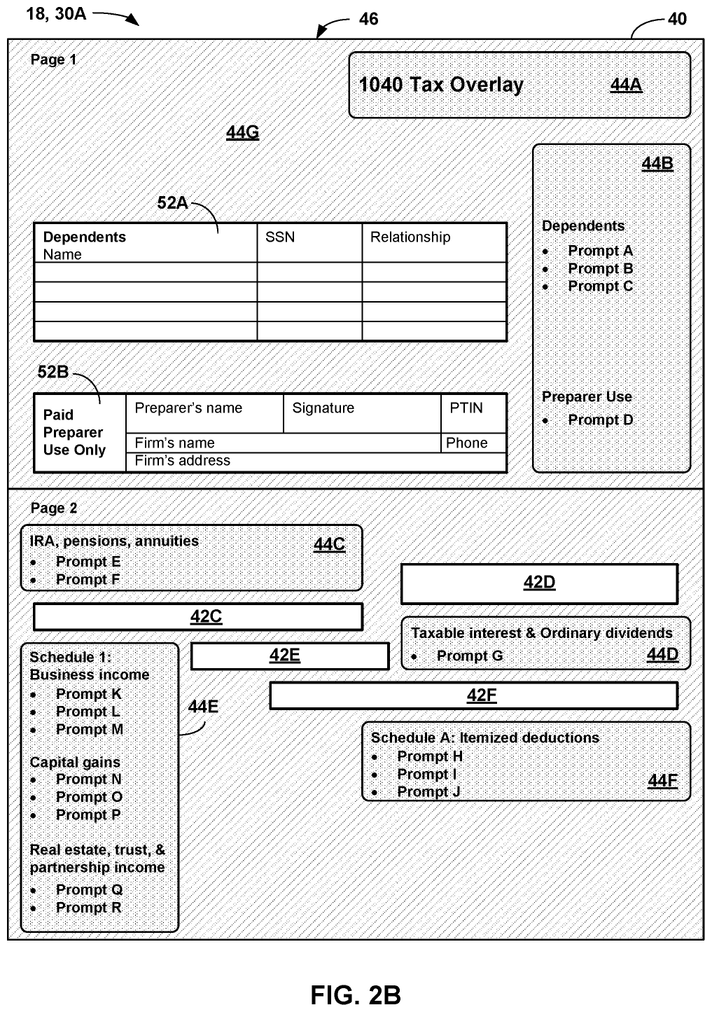

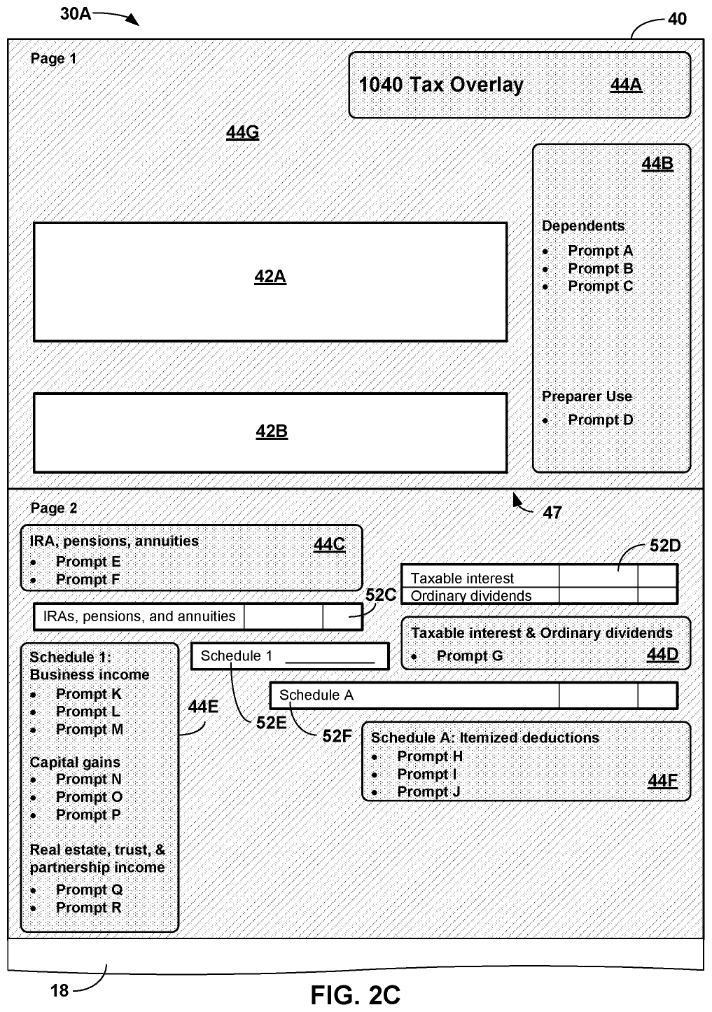

As described in more detail with respect to FIGS. 2A-2C, 3A-3C, and 4A-4D, overlay instrument 30 includes transparent regions and opaque regions positioned such that when overlay instrument 30 is placed over form 18 filled out by user 12, a first set of personal information of user 12 included on form 18 is visible through the transparent regions while as second set of personal information of user 12 included on form 18 is obscured by the opaque regions.

For example, the transparent regions of overlay instrument 30 are positioned to highlight or make visible the first set of personal information of user 12 included on form 18 that may be required for advisor 16 to provide the wealth management services, such as dependents information, tax preparer information, retirement account information, interest and dividends information, itemized deduction information, or additional income information. In addition, the opaque regions of overlay instrument 30 include one or more prompts for advisor 16 to gather additional information from user 12 based on the first set of the personal information of user 12 that is visible through the transparent regions. The opaque regions of overlay instrument 30 are further used to obscure confidential information of user 12 included on form 18, such as the user's social security number, from advisor 16.

Advisor 16 may use advisor device 20 to enter the additional information gathered from user 12 in response to questions prompted by overlay instrument 30 into a user profile for user 12 stored in user profiles database 22. In some examples, advisor 16 may use advisor device 20 to access an associated digital overlay user guide 32 stored in storage device 24. For example, depending on the additional information gathered from user 12 as prompted by overlay instrument 30, advisor 16 may follow one or more action items and/or access one or more resources recommended by overlay user guide 32 to assist user 12 with wealth management planning. In some cases, the recommended resources may comprise articles, checklists, or other planning strategy documents for use by advisor 16 and/or user 12.

Overlay instrument 30 is manufactured from a single sheet of material and may be one-sided or two-sided. The single sheet of material may comprise a flexible plastic film, a rigid plastic sheet, a laminated sheet of paper or card stock, or another type of material capable of being used repeatedly. The single sheet of material of overlay instrument 30 has dimensions substantially similar to form 18 for which the overlay instrument 30 is manufactured. In some examples, form 18 and overlay instrument 30 may each have dimensions substantially similar to the letter paper format of 8.5 by 11 inches. In other examples, form 18 and overlay instrument 30 may each have dimensions substantially similar to the legal paper format of 8.5 by 14 inches. In still other examples, form 18 may comprise a half letter format having dimensions of 8.5 by 5.5 inches or a postcard format having dimensions such as 8 by 6 inches or 7 by 5 inches, or the like. In these examples, overlay instrument 30 may comprise the same dimensions as form 18 or may comprise substantially similar dimensions as form 18, such a full letter format having dimensions of 8.5 by 11 inches. In one specific example, form 18 may by a two-page form comprising the half letter format, and overlay instrument 30 may be a single-sided overlay comprising the full letter format such that a top portion of overlay instrument 30 may be used for a first page of form 18 and a bottom portion of overlay instrument 30 may be used for a second page of form 18.

In order to manufacture overlay instrument 30, computing device 26 may be configured to first analyze a digital version of form 18 and determine positions of one or more queries included on form 18. For example, computing device 26 may include a scanner configured to scan a physical copy of form 18 (e.g., an unfilled, generic version of form 18 as provided by a publisher, or a specific version of form 18 filled out by user 12) and create a digital image of the particular form. Computing device 26 may then perform optical character recognition (OCR) or otherwise modify the digital image to create a searchable or interactive digital version of the particular form. In other examples, computing device 26 may retrieve a previously created digital version of the particular form from a database or, in some examples, directly from an agency or organization that authored the form, e.g., the IRS.

Computing device 26 then analyzes the digital version of form 18 to determine relative positions of each of the queries included on form 18 with respect to the other queries and with respect to borders of form 18. Computing device 26 generates a digital overlay template 34 based on the positions of the one or more queries on form 18. In some examples, overlay template 34 may be displayed for editing or approval by an operator of computing device 26. Computing device 26 may store overlay template 34 at storage device 24 that is accessible by computing device 26. In some examples, storage device 24 may store multiple different overlay templates 34 each generated for a different form or a different version of the same form. Computing device 26 then generates instructions to be executed by printing device 28 to manufacture physical overlay instrument 30 based on overlay template 34.

Printing device 28 receives a sheet of material having dimensions substantially similar to form 18 and the instructions from computing device 26. Based on the instructions received from computing device 26, printing device 28 defines one or more transparent regions on the sheet of material such that, when overlay instrument 30 is placed over form 18, a first set of the personal information of user 12 is visible through the transparent regions. Furthermore, based on the instructions received from computing device 26, printing device 28 defines one or more opaque regions on the sheet of material such that, when overlay instrument 30 is placed over form 18, the opaque regions obscure a second set of the personal information of user 12 from advisor 16. Based on the instructions received from computing device 26, printing device 28 also prints the one or more prompts on one or more of the opaque regions of overlay instrument 30.

In one example where the sheet of material comprises a transparent material, printing device 28 defines the opaque regions on the sheet of material by printing all regions of the sheet of material that are not designated as transparent regions with an opaque ink, and defines the transparent regions on the sheet of material as an absence of the opaque ink. In another example, wherein the sheet of material comprises an opaque material, printing device 28 defines the transparent regions on the sheet of material by die cutting the transparent regions from the sheet of material, and defines the one or more opaque regions on the sheet of material as all remaining regions of the sheet of material. In either example, printing device 28 may further define the opaque regions by printing one or more printed regions that include prompts based on the first set of personal information of the user, and defining at least one background region that includes all regions of the sheet of material that are not the transparent regions and the printed regions.

In some examples, based on the instructions received from computing device 26, printing device 28 may further laminate the sheet of material after the transparent and opaque regions are defined. For example, lamination may be especially useful in the case where the transparent regions are die-cut from the sheet of material.

FIGS. 2A-2C are conceptual diagrams illustrating an example of a one-sided physical overlay instrument 30A for a particular form 18, in accordance with the techniques of this disclosure. In this example, form 18 comprises a specific version of a 1040 tax form authored by the IRS.

FIG. 2A illustrates overlay instrument 30A comprising a sheet of material 40 on which transparent regions 42A-42F (collectively “transparent regions 42”) and opaque regions 44A-44G (collectively “opaque regions 44”) are defined on a single side to correspond to queries included on a first page of form 18 and a second page of form 18. Single sheet of material 40 has dimensions substantially similar to form 18. Single sheet of material 40 may comprise a flexible plastic film, a rigid plastic sheet, a laminated sheet of paper or card stock, or another type of material capable of being used repeatedly. The illustrated positions and quantities of transparent regions 42 and opaque regions 44 defined on sheet of material 40 are merely exemplary. Depending on a format of a particular form with which the overlay instrument is intended to be used, sheet of material 40 may include more or fewer transparent regions 42 and opaque regions 44 that are positioned differently than illustrated in FIG. 2A.

Transparent regions 42 are defined on sheet of material 40 such that, when physical overlay instrument 30A is placed over form 18, a first set of the personal information of the user is visible through the transparent regions. Opaque regions 44 are defined on sheet of material 40 such that, when physical overlay instrument 30A is placed over form 18, opaque regions 44 obscure a second set of the personal information of the user from a third party. In this way, overlay instrument 30A may assist in keeping the second set of personal information of the user that may be confidential, e.g., the user's social security number, secure. Moreover, opaque regions 44 include one or more prompts for the third party to gather additional information from the user based on the first set of the personal information of the user that is visible through transparent regions 42.

In an example where sheet of material 40 comprises a transparent material, opaque regions 44 may be defined with an opaque ink while transparent regions 42 may be defined as an absence of the opaque ink. In this example, opaque regions 44A-44F comprise printed regions that are further printed with text providing one or more prompts based on the set of personal information of the user that is visible through the transparent regions 42 when overlay instrument 30A is placed over form 18. Opaque region 44G may comprise a background region printed with a solid color or pattern that includes all the regions of sheet of material 40 that are not transparent regions 42 or printed regions 44A-44F.

In another example where sheet of material 40 comprises an opaque material, transparent regions 42 may be defined as die cut openings or “holes” in sheet of material 40 while opaque regions 44 may be defined as all the remaining regions of sheet of material 40. In this example, opaque regions 44A-44F comprise printed regions that are printed with text providing one or more prompts based on the set of personal information of the user that is visible through the transparent regions 42 when overlay instrument 30A is placed over form 18. Opaque region 44G may comprise an unprinted background region that includes all the regions of sheet of material 40 that are not transparent regions 42 or printed regions 44A-44F.

FIG. 2B illustrates overlay instrument 30A placed over a first page of form 18 and aligned such that queries 52A-52B included on the first page of form 18 are visible through transparent regions 42A-42B, respectively. In the example of FIG. 2B, transparent regions 42A-42B are defined at positions within a top portion of sheet of material 40 (e.g., labeled “Page 1”) in order to align with queries 52A-52B included on the first page of form 18. In some examples, transparent regions 42A-42B may properly align with queries 52A-52B on the first page of form 18 when a top edge 46 of overlay instrument 30A is aligned with a top edge of the first page of form 18.

In one example, form 18 comprises a full letter paper format of 8.5 by 11 inches or a half-letter paper format of 8.5 by 5.5 inches, while overlay instrument 30A comprises the full letter paper format of 8.5 by 11 inches such that a top portion (“Page 1”) may be used for the first page of form 18 and a bottom portion (“Page 2”) may be used for a second page of form 18. In this example, transparent region 42A may be defined on sheet of material 40 with a top-left corner positioned approximately 2.8 inches below the top edge 46 of overlay instrument 30A and approximately 0.5 inches from the left edge of overlay instrument 30A. Transparent region 42A may have dimensions of approximately 5.25 by 1 inches. Transparent region 42B may be defined on sheet of material 40 with a top-left corner positioned approximately 4.75 inches below the top edge 46 of overlay instrument 30A and approximately 0.5 inches from the left edge of overlay instrument 30A. Transparent region 42B may have dimensions of approximately 5.75 by 0.75 inches.

When filled out by a user, queries 52A-52B include personal information of the user that is that visible through transparent regions 42A-42B, respectively. In the illustrated example in which form 18 comprises a specific version of a 1040 tax form, query 52A comprises a query for personal information about the user's dependents including dependents names, social security numbers, and relationship to the user. In some examples, transparent region 42A may be reduced or modified such that only the user's dependents' names and/or relationship are visible when overlay instrument 30A is placed over the first page of form 18 and the dependents' social security numbers may be obscured by background opaque region 44G. In the example of FIG. 2B, query 52B comprises a query for personal information about the user's paid tax preparer (if applicable) including the preparer's name, signature, and contact information.

In some examples, one or more of printed opaque regions 44A-44B are defined at positions within the top portion of sheet of material 40 in order to obscure one or more other queries, or more specifically the personal information of the user included in the other queries, included on the first page of form 18. For example, printed opaque region 44A may obscure a query on the first page of form 18 that requests the user's social security number. In other examples, one or more of printed opaque regions 44A-44B are defined at any positions within the top portion of sheet of material 40 such that the included prompts are clearly associated with queries 52A-52B. In the example of FIG. 2B, printed opaque region 44B includes prompts A, B, and C related to the personal information about the user's dependents included in query 52A visible through transparent region 42A. Printed opaque region 44B also includes prompt D related to the personal information about the user's paid tax preparer included in query 52B visible through transparent region 42B.

In other examples, arrows may be printed over background opaque region 44G connecting the printed prompts in opaque region 44B with the transparent regions 42A, 42B through which the associated queries 52A, 52B on the first page of form 18 are visible. In still other examples, printed opaque region 44B may be divided into two or more separate opaque regions each dedicated to one of queries 52A, 52B.

As discussed above with respect to FIG. 1, advisor 16 may use overlay instrument 30A to guide conversations with user 12 regarding the user's finances, credit potential, and wealth management needs based on personal information already available from the user's most recently filled out tax form, e.g., form 18. In some scenarios, advisor 16 may conduct the conversations with user 12 using overlay instrument 30A while also accessing an associated overlay user guide 32 via advisor device 20.

In an example use case, once advisor 16 has placed overlay instrument 30A over the first page of form 18 filled out by user 12 and aligned transparent regions 42A-42B with queries 52A-52B included on the first page of form 18, advisor 16 may present questions or statements to user 12 based on the prompts included in printed opaque region 44B to gather additional information from user 12 based on the personal information included in queries 52A-52B visible through transparent regions 42A-42B, respectively. As one example, with respect to the user's dependents, prompt A included in printed opaque region 44B may be directed to the user's plans to meet higher education costs for the user's dependents, prompt B may be directed to the user's plans to financially support the user's dependents and other family members, and prompt C may be directed to whether the user has incorporated these plans into a gifting or estate plan. As another example, with respect to the user's tax preparer, prompt D included in printed opaque region 44B may be directed to whether advisor 16 can share any information discussed during the wealth management conversations with the user's tax preparer or request any missing information from the user's tax preparer.

Advisor 16 may enter the additional information gathered in response to the questions or statements presented to user 12 based on prompts A-D into a user profile 22 for user 12 via advisor device 20. In addition, depending on the additional information gathered from user 12, advisor 16 may follow one or more action items and/or access one or more resources recommended by overlay user guide 32 to assist user 12 with wealth management planning. In some cases, the recommended resources may comprise articles, checklists, or other planning strategy documents for use by advisor 16 and/or user 12.

FIG. 2C illustrates overlay instrument 30A placed over a second page of form 18 and aligned such that queries 52C-52F included on the second page of form 18 are visible through transparent regions 42C-42F, respectively. In the example of FIG. 2C, transparent regions 42C-42F are defined at positions within a bottom portion of sheet of material 40 (e.g., labeled “Page 2”) in order to align with queries 52C-52F included on the second page of form 18. In some examples, transparent regions 42C-42F may properly align with queries 52C-52F on the second page of form 18 when a midline 47 printed over background opaque region 44G between the top portion (“Page 1”) and the bottom portion (“Page 2”) of sheet of material 40 is aligned with a top edge of the second page of form 18.

In one example, form 18 comprises a full letter paper format of 8.5 by 11 inches or a half-letter paper format of 8.5 by 5.5 inches, while overlay instrument 30A comprises the full letter paper format of 8.5 by 11 inches such that a top portion (“Page 1”) may be used for the first page of form 18 and a bottom portion (“Page 2”) may be used for the second page of form 18. In this example, transparent region 42C may be defined on sheet of material 40 with a top-left corner positioned approximately 1 inch below the midline 47 or 6.5 inches below top edge 46 of overlay instrument 30A and approximately 1.25 inches from the left edge of overlay instrument 30A. Transparent region 42C may have dimensions of approximately 3.5 by 0.125 inches. Transparent region 42D may be defined on sheet of material 40 with a top-left corner positioned approximately 0.75 inches below the midline 47 or 6.25 inches below the top edge 46 of overlay instrument 30A and approximately 4.8 inches from the left edge of overlay instrument 30A. Transparent region 42D may have dimensions of approximately 3.2 by 0.25 inches. Transparent region 42E may be defined on sheet of material 40 with a top-left corner positioned approximately 1.375 inches below the midline 47 or 6.875 inches below the top edge 46 of overlay instrument 30A and approximately 1.25 inches from the left edge of overlay instrument 30A. Transparent region 42E may have dimensions of approximately 4.25 by 0.125 inches. Transparent region 42F may be defined on sheet of material 40 with a top-left corner positioned approximately 1.8 inches below the midline 47 or 7.3 inches below the top edge 46 of overlay instrument 30A and approximately 3.75 inches from the left edge of overlay instrument 30A. Transparent region 42F may have dimensions of approximately 4.25 by 0.125 inches.

When filled out by a user, queries 52C-52F include personal information of the user that is that visible through transparent regions 42C-42F, respectively. In the illustrated example in which form 18 comprises a specific version of a 1040 tax form, query 52C comprises a query for personal information about the user's IRAs, pensions, and annuities. Query 52D comprises a query for personal information about the user's taxable interest and ordinary dividends. Query 52E comprises a query for a total amount from the user's Schedule 1, which includes business income, capital gains, and real estate, trust and partnership income. Query 52F comprises a query for an itemized deduction amount from the user's Schedule A.

In some examples, one or more of printed opaque regions 44C-44F are defined at positions within the bottom portion of sheet of material 40 in order to obscure one or more other queries, or more specifically the personal information of the user included in the other queries, included on the second page of form 18. In other examples, one or more of printed opaque regions 44C-44F are defined at any positions within the bottom portion of sheet of material 40 such that the included prompts are clearly associated with queries 52C-52F. In the example of FIG. 2C, printed opaque region 44C includes prompts E and F related to the personal information about the user's IRAs, pensions, and annuities included in query 52C visible through transparent region 42C. Printed opaque region 44D includes prompt G related to the personal information about the user's taxable interest and ordinary dividends in query 52D visible through transparent region 42D. Printed opaque region 44E includes prompts for each of multiple sources of income included in the total amount from the user's Schedule 1 in query 52E visible through transparent region 42E. More specifically, printed opaque region 44E includes prompts K, L, and M related to the personal information about the user's business income included on Schedule 1. Printed opaque region 44E also includes prompts N, O, and P related to the personal information about the user's capital gains included on Schedule 1. Printed opaque region 44E further includes prompts Q and R related to the personal information about the user's real estate, trust, and partnership income included on Schedule 1. Printed opaque region 44F includes prompts H, I, and J related to the personal information about the user's itemized deductions on Schedule A included in the deduction amount in query 52F visible through transparent region 42F.

In other examples, arrows may be printed over background opaque region 44G connecting the printed prompts in one or more of opaque regions 44C-44F with the transparent regions 42C-44F through which the associated queries 52C-52F on the second page of form 18 are visible. In still other examples, printed opaque region 44E may be divided into two or more separate opaque regions each dedicated to one of the sources of income on the user's Schedule 1.

Continuing the example use case described with respect to FIG. 2B, once advisor 16 has placed overlay instrument 30A over the second page of form 18 filled out by user 12 and aligned transparent regions 42C-42F with queries 52C-52F included on the second page of form 18, advisor 16 may present questions or statements to user 12 based on the prompts included in printed opaque regions 44C-44F to gather additional information from user 12 based on the personal information included in queries 52C-52F visible through transparent regions 42C-42F, respectively.

As one example, with respect to the user's IRAs, pensions, and annuities, prompt E included in printed opaque region 44C may be directed to the user's vision for their retirement years, and prompt F may be directed to the user's sources of income during their retirement years. In some examples, additional prompts may be included in printed opaque region 44C directed to the user's concerns about their income sources and meeting their retirement goals. As another example, with respect to the user's taxable interest and ordinary dividends, prompt G included in printed opaque region 44D may be directed to the user's sources of liquidity and any foreseeable need for additional liquidity.

As an additional example, with respect to the user's itemized deductions included in Schedule A, prompt H included printed opaque region 44F may be directed to what charities or causes that the user supports, prompt I may be directed to what additional causes the user cares about and wants to support in the future, and prompt J may be directed to how the user has formalized their giving plans or solicited family participation. As a further example, with respect to the user's business income included in Schedule 1, prompt K included in printed opaque region 44E may be directed to how the user's business team and management is structured, prompt L may be directed to the extent to which the user and others are dependent on the business as a source of livelihood, and prompt M may be directed to the user's succession plan and transition or exist strategy from the business. With respect to the user's capital gains income included in Schedule 1, prompt N included in printed opaque region 44E may be directed to how the user coordinates timing of recognition of gains and losses across multiple portfolios together with non-portfolio tax events, prompt O may be directed to the how the user's portfolio is structured to access liquidity while minimizing tax impact, and prompt P may be directed to how the user's investment portfolio(s) are structured to achieve specific short and long term goals. With respect to the user's real estate, trust, and partnership income included in Schedule 1, prompt Q included in printed opaque region 44E may be directed to any land or investment properties owned by the user, and prompt R may be directed to the user's longer term strategies for the properties the user owns.

Advisor 16 may enter the additional information gathered in response to the questions or statements presented to user 12 based on prompts E-R into the user profile 22 for user 12 via advisor device 20. In addition, depending on the additional information gathered from user 12, advisor 16 may follow one or more action items and/or access one or more resources recommended by overlay user guide 32 to assist user 12 with wealth management planning. In some cases, the recommended resources may comprise articles, checklists, or other planning strategy documents for use by advisor 16 and/or user 12.

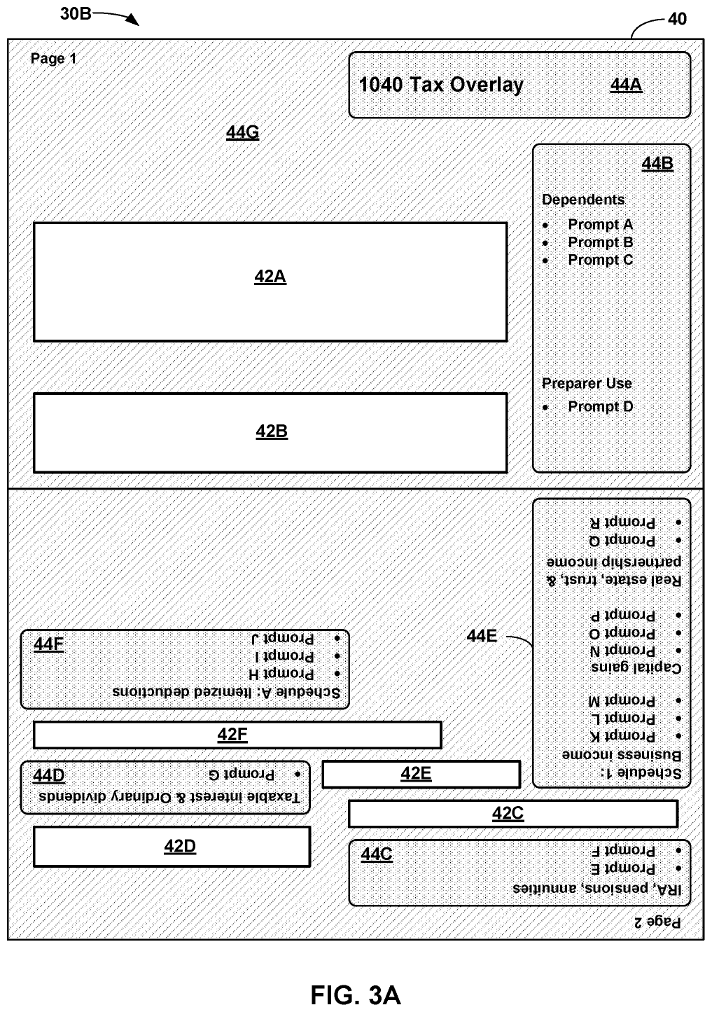

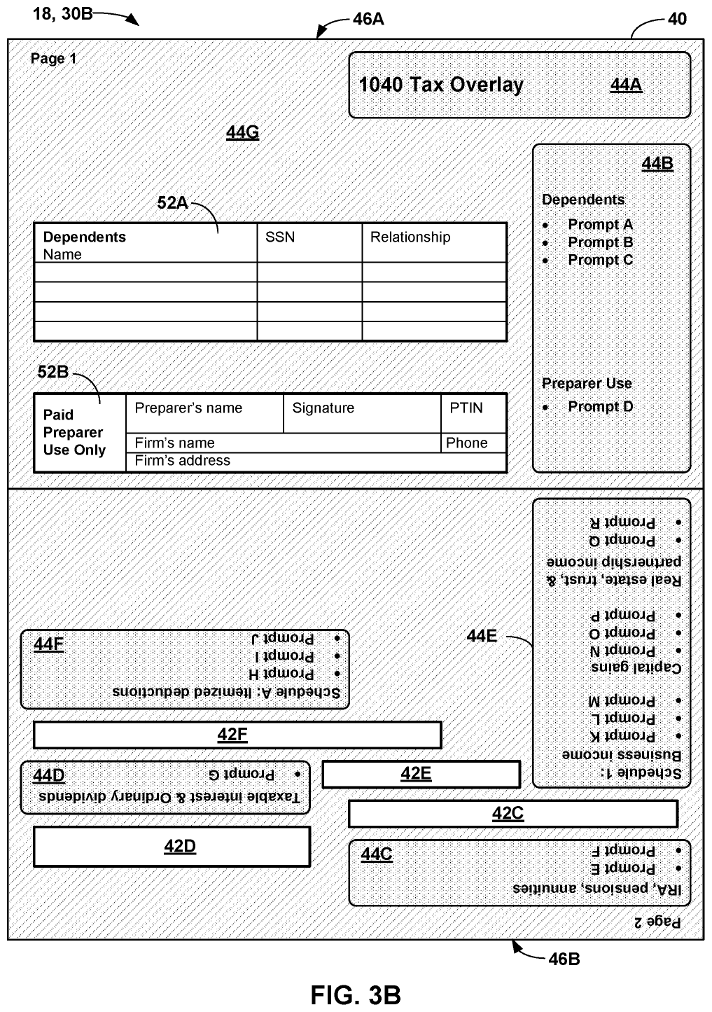

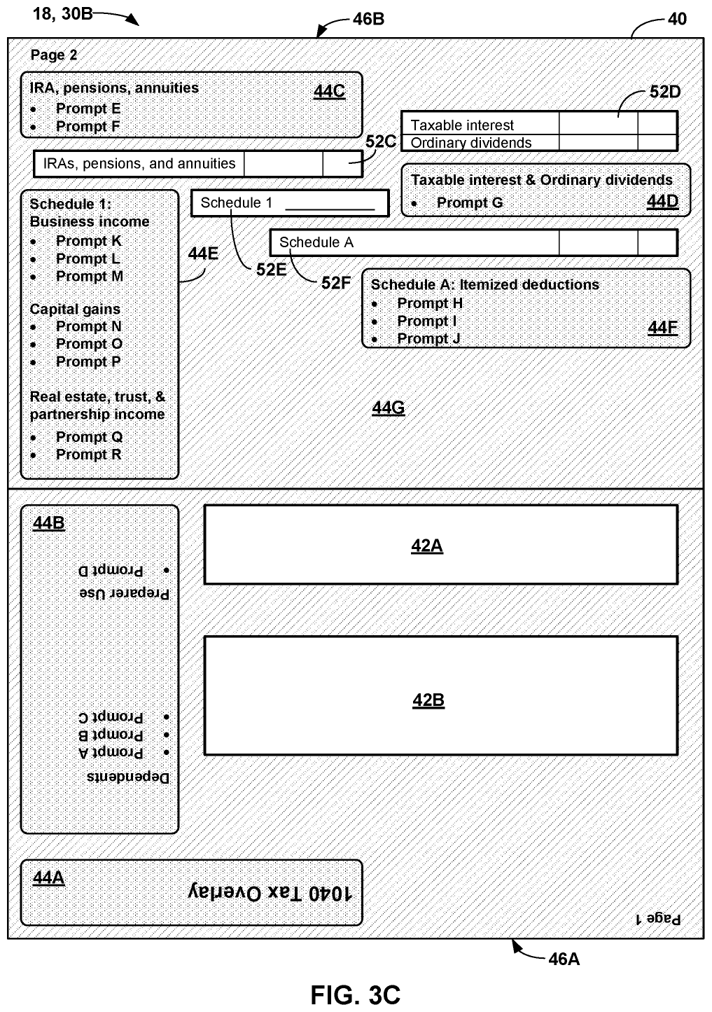

FIGS. 3A-3C are conceptual diagrams illustrating another example of a one-sided physical overlay instrument 30B for a particular form 18, in accordance with the techniques of this disclosure. In this example, form 18 again comprises a specific version of a 1040 tax form authored by the IRS. As further described below, overlay instrument 30B is formatted such that the defined regions 42, 44 align with queries on a first page of form 18 when the instrument is in a first orientation, and align with queries on a second page of form 18 when the instrument is rotated 180 degrees to a second orientation.

FIG. 3A illustrates overlay instrument 30B comprising a sheet of material 40 on which transparent regions 42 and opaque regions 44 are defined on a single side to correspond to queries included on a first page of form 18 and a second page of form 18. Single sheet of material 40 has dimensions substantially similar to form 18. Single sheet of material 40 may comprise a flexible plastic film, a rigid plastic sheet, a laminated sheet of paper or card stock, or another type of material capable of being used repeatedly. The illustrated positions and quantities of transparent regions 42 and opaque regions 44 defined on sheet of material 40 are merely exemplary. Depending on a format of a particular form with which the overlay instrument is intended to be used, sheet of material 40 may include more or fewer transparent regions 42 and opaque regions 44 that are positioned differently than illustrated in FIG. 3A.

Transparent regions 42 and opaque regions 44 of overlay instrument 30B are positioned on sheet of material 40 to align with the same queries included on form 18 as described above with respect to FIGS. 2A-2C. Moreover, printed opaque regions 44A-44F of overlay instrument 30B may include the same or similar prompts as described above with respect to FIGS. 2A-2C with respect to the personal information of the user included on form 18 and visible through transparent regions 42. As illustrated in FIG. 3A, the format of overlay instrument 30B is different than that of overlay instrument 30A from FIG. 2A in that transparent regions 42A-42B and opaque regions 44A-44B are defined in a first orientation within a top portion of sheet of material 40 (e.g., labeled “Page 1”) while transparent regions 42D-42F and opaque regions 44C-44F are defined in a second orientation within a bottom portion of sheet of material 40 (e.g., labeled “Page 2”). More specifically, in the illustrated example, transparent regions 42D-42F and opaque regions 44C-44F are defined within the bottom portion of sheet of material 40 in the second orientation that is rotated 180 degrees from the first orientation of transparent regions 42A-42B and opaque regions 44A-44B defined within the top portion of sheet of material 40.

FIG. 3B illustrates overlay instrument 30B placed over a first page of form 18 and aligned such that queries 52A-52B included on the first page of form 18 are visible through transparent regions 42A-42B, respectively. In the example of FIG. 3B, transparent regions 42A-42B are defined at positions within the top portion of sheet of material 40 (e.g., labeled “Page 1”) in order to align with queries 52A-52B included on the first page of form 18. In some examples, transparent regions 42A-42B may properly align with queries 52A-52B on the first page of form 18 when a top edge 46A of overlay instrument 30B is aligned with a top edge of the first page of form 18 and a bottom edge 46B of overlay instrument 30B is aligned with a bottom edge of the first page of form 18.

Transparent regions 42A-42B of overlay instrument 30B may have substantially similar dimensions as described above with respect to overlay instrument 30A from FIG. 2B. Transparent regions 42A-42B may also be defined at substantially similar positions with respect to the top edge 46A and the left edge of overlay instrument 30B as described above with respect to the top edge 46 and left edge of overlay instrument 30A from FIG. 2B.

FIG. 3C illustrates overlay instrument 30B placed over a second page of form 18 and aligned such that queries 52C-52F included on the second page of form 18 are visible through transparent regions 42C-42F, respectively. In the example of FIG. 3C, transparent regions 42C-42F are defined at positions within the bottom portion of sheet of material 40 (e.g., labeled “Page 2”) in order to align with queries 52C-52F included on the second page of form 18. In some examples, transparent regions 42C-42F may properly align with queries 52C-52F on the second page of form 18 when overlay instrument 30B is rotated 180 degrees such that bottom edge 46B of overlay instrument 30B is aligned with a top edge of the second page of form 18 and top edge 46A of overlay instrument 30B is aligned with a bottom edge of the second page of form 18.

Transparent regions 42C-42F of overlay instrument 30B may have substantially similar dimensions as described above with respect to overlay instrument 30A from FIG. 2C. Transparent regions 42A-42B may also be defined at substantially similar positions with respect to the bottom edge 46B and the right edge of overlay instrument 30B as described above with respect to the midline 47 and left edge of overlay instrument 30A from FIG. 2C.

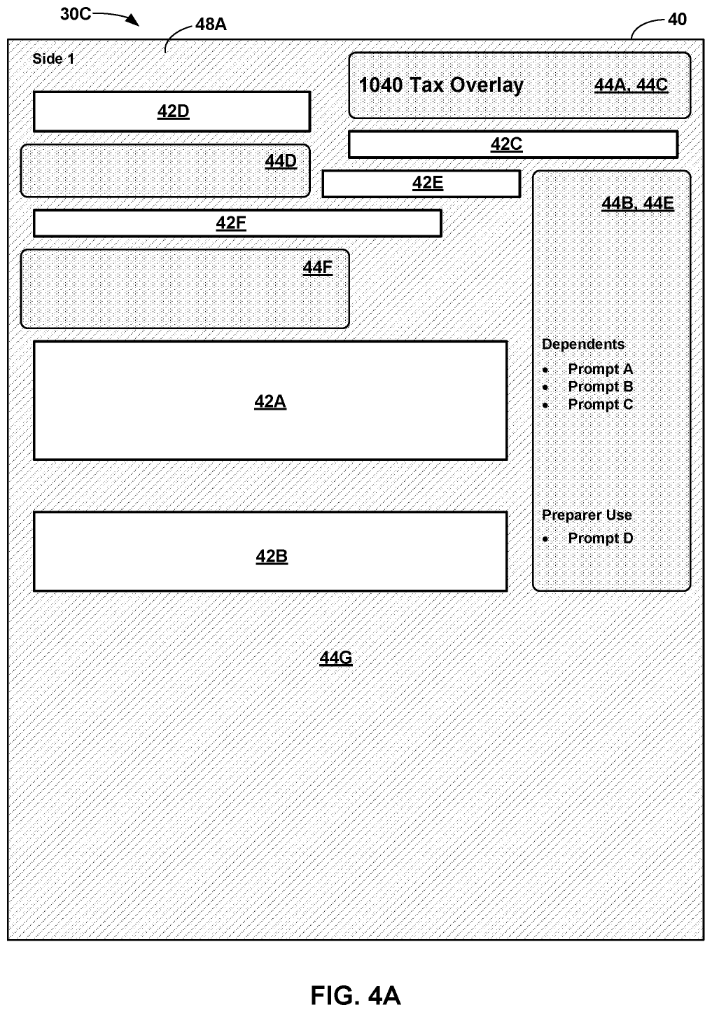

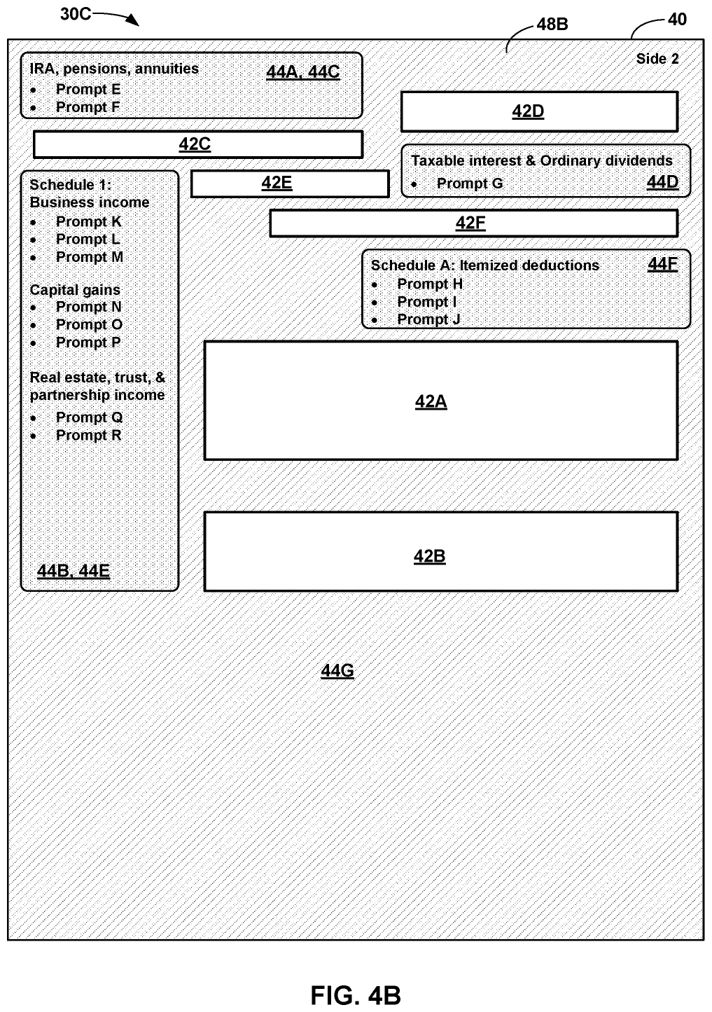

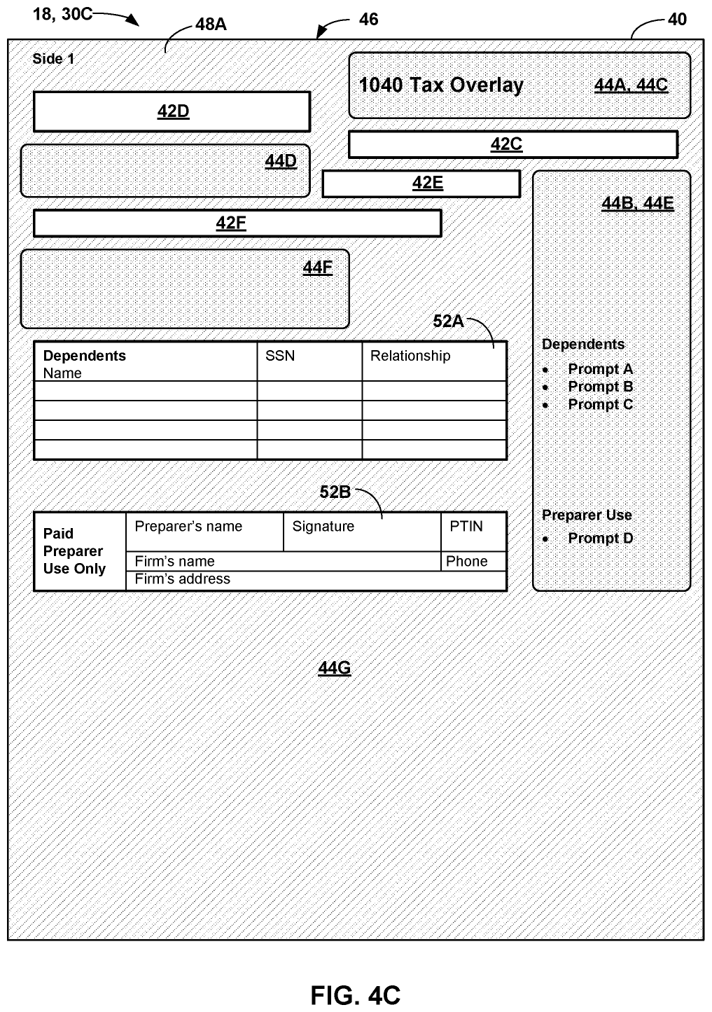

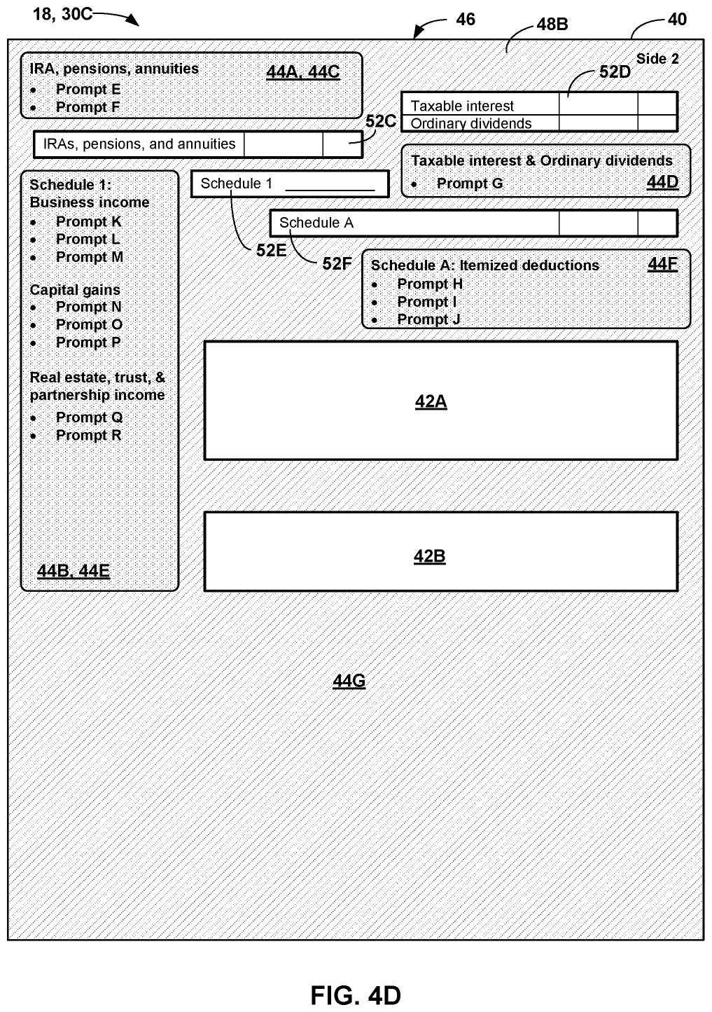

FIGS. 4A-4D are conceptual illustrating an example of a two-sided physical overlay instrument 30C for a particular form 18, in accordance with the techniques of this disclosure. In this example, form 18 again comprises a specific version of a 1040 tax form authored by the IRS. As further described below, overlay instrument 30C is formatted such that the defined regions 42, 44 align with queries on a first page of form 18 when a first side of the instrument is placed over the first page of form 18, and align with queries on a second page of form 18 when the instrument is flipped over and a second side of the instrument is placed over the second page of form 18.

FIG. 4A illustrates a first side 48A of overlay instrument 30C and FIG. 4B illustrates a second side 48B of overlay instrument 30C. Overlay instrument 30C comprises a sheet of material 40 on which transparent regions 42 and opaque regions 44 are defined to correspond to queries included on a first page of form 18 and a second page of form 18. Single sheet of material 40 has dimensions substantially similar to form 18. Single sheet of material 40 may comprise a flexible plastic film, a rigid plastic sheet, a laminated sheet of paper or card stock, or another type of material capable of being used repeatedly. The illustrated positions and quantities of transparent regions 42 and opaque regions 44 defined on sheet of material 40 are merely exemplary. Depending on a format of a particular form with which the overlay instrument is intended to be used, sheet of material 40 may include more or fewer transparent regions 42 and opaque regions 44 that are positioned differently than illustrated in FIGS. 4A-4B.

Transparent regions 42 and opaque regions 44 of overlay instrument 30C are positioned on sheet of material 40 to align with the same queries included on form 18 as described above with respect to FIGS. 2A-2C. Moreover, printed opaque regions 44A-44F of overlay instrument 30C may include the same or similar prompts as described above with respect to FIGS. 2A-2C with respect to the personal information of the user included on form 18 and visible through transparent regions 42.

As illustrated in FIGS. 4A-4B, the format of overlay instrument 30C is different than that of overlay instrument 30A from FIG. 2A or overlay instrument 30B from FIG. 3A in that transparent regions 42 and opaque regions 44 are defined within a same top portion of sheet of material 40. In the example of FIG. 4A, transparent regions 42A-42B are defined such that first side 48A of overlay instrument 30C aligns with queries on the first page of form 18. In addition, opaque regions 44A and 44B are printed with text on first side 48A, e.g., providing the prompts based on the personal information included on the first page of form 18 that is visible through the transparent regions 42A-42B. As described below, printed opaque regions 44A, 44B on first side 48A may be reused as printed opaque regions 44C, 44E, respectively, on second side 48B. Opaque regions 44D and 44F may be defined without text on first side 48A as shown in FIG. 4A. In the example of FIG. 4B, transparent regions 42C-42F are defined such that second side 48B of overlay instrument 30C aligns with queries on the second page of form 18, and opaque regions 44C-44F are printed with text on second side 48B providing the prompts based on the personal information included on the second page of form 18 that is visible through the transparent regions 42C-42F.

In some examples, at least some of printed opaque regions 44A-44F may overlap between first side 48A and second side 48B of overlay instrument 30C. In the illustrated example of FIGS. 4A-4B, printed opaque region 44A on first side 48A, which may be used to obscure confidential information of the user included on the first page of form 18, may comprise printed opaque region 44C on second side 48B, which includes prompts related to the personal information about the user's IRAs, pensions, and annuities included on the second page of form 18 and visible through transparent region 42C. As further illustrated in FIGS. 4A-4B, printed opaque region 44B on first side 48A, which includes prompts related to the personal information about the user's dependents and the user's tax preparer included on the first page of form 18 and visible through transparent regions 42A and 42B, may comprise printed opaque region 44E on second side 48B, which includes prompts related to the personal information about the user's sources of income on Schedule 1 included on the second page of form 18 and visible through transparent region 42E.

FIG. 4C illustrates first side 48A of overlay instrument 30C placed over a first page of form 18 and aligned such that queries 52A-52B included on the first page of form 18 are visible through transparent regions 42A-42B, respectively. In the example of FIG. 4C, transparent regions 42A-42B are defined at positions within the top portion of first side 48A of sheet of material 40 (e.g., labeled “Side 1”) in order to align with queries 52A-52B included on the first page of form 18. In some examples, transparent regions 42A-42B may properly align with queries 52A-52B on the first page of form 18 when a top edge 46 of first side 48A of overlay instrument 30C is aligned with a top edge of the first page of form 18.

Transparent regions 42A-42B on first side 48A of overlay instrument 30C may have substantially similar dimensions as described above with respect to overlay instrument 30A from FIG. 2B. Transparent regions 42A-42B may also be defined at substantially similar positions with respect to the top edge 46 and the left edge of first side 48A of overlay instrument 30C as described above with respect to the top edge 46 and left edge of overlay instrument 30A from FIG. 2B.

FIG. 4D illustrates second side 48B of overlay instrument 30C placed over a second page of form 18 and aligned such that queries 52C-52F included on the second page of form 18 are visible through transparent regions 42C-42F, respectively. In the example of FIG. 4D, transparent regions 42C-42F are defined at positions within the top portion of second side 48B of sheet of material 40 (e.g., labeled “Side 2”) in order to align with queries 52C-52F included on the second page of form 18. In some examples, transparent regions 42C-42F may properly align with queries 52C-52F on the second page of form 18 when overlay instrument 30C is flipped over and top edge 46 of second side 48B of overlay instrument 30C is aligned with a top edge of the second page of form 18.

Transparent regions 42C-42F on second side 48B of overlay instrument 30C may have substantially similar dimensions as described above with respect to overlay instrument 30A from FIG. 2C. Transparent regions 42A-42B may also be defined at substantially similar positions with respect to the top edge 46 and the left edge of the second side 48B of overlay instrument 30C as described above with respect to the midline 47 and left edge of overlay instrument 30A from FIG. 2C.

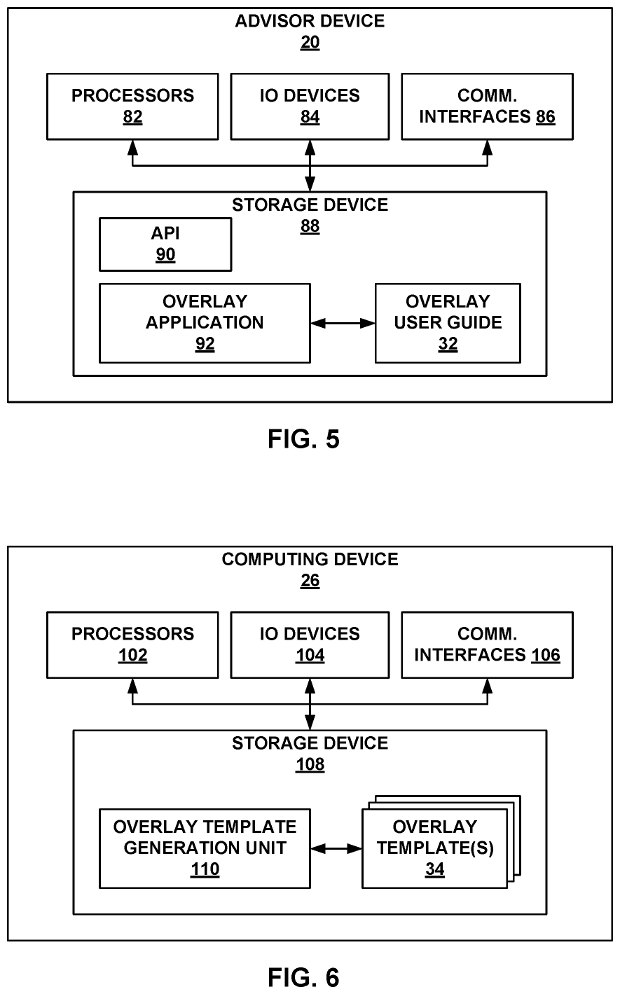

FIG. 5 is a block diagram illustrating an example advisor device configured to access an overlay user guide for use in conjunction with the physical overlay instrument, in accordance with the techniques of this disclosure. One or more aspects of advisor device 20 of FIG. 5 may be described within the context of wealth management system 10 of FIG. 1.

Advisor device 20 may be implemented as any suitable computing system, such as one or more server computers, workstations, mainframes, appliances, cloud computing systems, and/or other computing systems that may be capable of performing operations and/or functions described in accordance with one or more aspects of the present disclosure. The architecture of advisor device 20 illustrated in FIG. 5 is shown for exemplary purposes only. Advisor device 20 should not be limited to the illustrated example architecture. In other examples, advisor device 20 may be configured in a variety of ways.

As shown in the example of FIG. 5, advisor device 20 includes one or more processors 82, one or more input/output (IO) devices 84, one or more communication interfaces 86, and one or more storage units 88. Advisor device 20 also includes an application programming interface (API) 90 and overlay application 92, which may each be implemented as program instructions and/or data stored in storage device 88 and executable by processors 82 or implemented as one or more hardware units or devices of advisor device 20. Storage device 88 of advisor device 20 may also store an operating system (not shown) executable by processors 82 to control the operation of components of advisor device 20. The components, units or modules of advisor device 20 are coupled (physically, communicatively, and/or operatively) using communication channels for inter-component communications. In some examples, the communication channels may include a system bus, a network connection, an inter-process communication data structure, or any other method for communicating data.

Processors 82, in one example, may comprise one or more processors that are configured to implement functionality and/or process instructions for execution within advisor device 20. For example, processors 82 may be capable of processing instructions stored by storage device 88. Processors 82 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Storage device 88 may be configured to store information within advisor device 20 during operation. Storage device 88 may include a computer-readable storage medium or computer-readable storage device. In some examples, storage device 88 include one or more of a short-term memory or a long-term memory. Storage device 88 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage device 88 is used to store program instructions for execution by processors 82. Storage device 88 may be used by software or applications running on advisor device 20 (e.g., overlay application 92) to temporarily store information during program execution. Storage device 88 of advisor device 20 may optionally store overlay user guide 32 for use by overlay application 92. In other examples, overlay user guide 32 may be stored at a remote location, e.g., storage device 24 from FIG. 1, accessible by overlay application 92 via communication interfaces 86.

IO devices 84 may include one or more input devices that receive input and one or more output devices that generate output. Examples of input are tactile, audio, and video input. Examples of input devices include a presence-sensitive screen, touch-sensitive screen, mouse, keyboard, voice responsive system, video camera, microphone or any other type of device for detecting input from a human or machine. Examples of output are tactile, audio, and video output. Examples of output devices include a presence-sensitive screen, sound card, video graphics adapter card, speaker, cathode ray tube (CRT) monitor, liquid crystal display (LCD), or any other type of device for generating output to a human or machine. For example, IO devices 84 of advisor device 20 may include a keyboard and mouse used by advisor 16 to input information gathered from user 12 in accordance with overlay instrument 30 and overlay user guide 32. IO devices 84 of advisor device 20 may further include a display device to output data to advisor 16 while in discussion with user 12, such as data from one of user profiles 22 associated with user 12 and instructions from overlay user guide 32.

Advisor device 20 may utilize communication interfaces 86 to communicate with one or more other devices via one or more networks (e.g., network 14 from FIG. 1) by transmitting and/or receiving network signals on the one or more networks. Examples of communication interfaces 86 include a network interface card (e.g. such as an Ethernet card), an optical transceiver, a radio frequency transceiver, or any other type of device that can send and/or receive information, such as through a wired or wireless network. Other examples of communication interfaces 86 may include short wave radios, cellular data radios, wireless Ethernet network radios, as well as universal serial bus (USB) controllers. In some examples, advisor device 20 utilizes communication interfaces 86 to wirelessly communicate with external devices, e.g., user profiles database 22, storage device 24, and/or computing device 26 of wealth management system 10 from FIG. 1.

In the illustrated example of FIG. 5, advisor device 20 includes API 90 and overlay application 92. In accordance with the disclosed techniques, advisor device 20 is configured to execute overlay application 92 to present digital overlay user guide 32 to advisor 16 via one of IO devices 84 of advisor device 20. For example, while having a wealth management conversation with user 12 based on the prompts included on overlay instrument 30, advisor 16 may follow one or more action items and/or access one or more resources recommended by overlay user guide 32 to assist user 12 with wealth management planning. In some scenarios, overlay application 92 may present overlay user guide 32 to advisor 16 as an interactive user guide in which the recommended action items and/or resources are linked to articles, checklists, or other planning strategy documents for use by advisor 16 and/or user 12.

In addition, advisor device 20 executes overlay application 92 to send data representative of a user interface used to present and receive changes to a user profile 22 for user 12 via one or IO devices 84 of advisor device 20. For example, while having a wealth management conversation with user 12 based on the prompts included on overlay instrument 30, advisor 16 may enter the additional information gathered from user 12 into the user profile for user 12 stored in user profiles database 22.

In some examples, instead of advisor 16 receiving a physical copy of the user's complete form 18, advisor device 20 may instead use API 90 to retrieve a digital copy of the user's completed form 18 directly from an agency or organization with which the completed form was filed, e.g., the IRS. Advisor 16 may then print the copy of the user's complete form 18 for use with physical overlay instrument 30 to guide the wealth management conversation. Moreover, although primarily described herein as using a physical copy of the user's completed form 18 and physical overlay instrument 30 to guide the wealth management conversations between advisor 16 and user 12, in other examples similar guidance may be provided based on the digital copy of the user's completed form 18 and a digital version of the overlay instrument.

FIG. 6 is a block diagram illustrating an example computing device configured to generate an overlay template used by a printing device to manufacture the physical overlay instrument, in accordance with the techniques of this disclosure. One or more aspects of computing device 26 of FIG. 6 may be described within the context of wealth management system 10 of FIG. 1.

Computing device 26 may be implemented as any suitable computing system, such as one or more server computers, workstations, mainframes, appliances, cloud computing systems, and/or other computing systems that may be capable of performing operations and/or functions described in accordance with one or more aspects of the present disclosure. The architecture of computing device 26 illustrated in FIG. 6 is shown for exemplary purposes only. Computing device 26 should not be limited to the illustrated example architecture. In other examples, computing device 26 may be configured in a variety of ways.

As shown in the example of FIG. 6, computing device 26 includes one or more processors 102, one or more input/output (IO) devices 104, one or more communication interfaces 106, and one or more storage units 108. Computing device 26 also includes an overlay template generation unit 110, which may be implemented as program instructions and/or data stored in storage device 108 and executable by processors 102 or implemented as one or more hardware units or devices of computing device 26. Storage device 108 of computing device 26 may also store an operating system (not shown) executable by processors 102 to control the operation of components of computing device 26. The components, units or modules of computing device 26 are coupled (physically, communicatively, and/or operatively) using communication channels for inter-component communications. In some examples, the communication channels may include a system bus, a network connection, an inter-process communication data structure, or any other method for communicating data.

Processors 102, in one example, may comprise one or more processors that are configured to implement functionality and/or process instructions for execution within computing device 26. For example, processors 102 may be capable of processing instructions stored by storage device 108. Processors 102 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Storage device 108 may be configured to store information within computing device 26 during operation. Storage device 108 may include a computer-readable storage medium or computer-readable storage device. In some examples, storage device 108 include one or more of a short-term memory or a long-term memory. Storage device 108 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage device 108 is used to store program instructions for execution by processors 102. Storage device 108 may be used by software or applications running on computing device 26 (e.g., overlay template generation unit 110) to temporarily store information during program execution. Storage device 108 of computing device 26 may optionally store overlay templates 34 output from overlay template generation unit 110. In other examples, one or more of overlay templates 34 may be stored at a remote location, e.g., storage device 24 from FIG. 1, accessible by computing device 26 via communication interfaces 106.

IO devices 10 may include one or more input devices that receive input and one or more output devices that generate output. Examples of input are tactile, audio, and video input. Examples of input devices include a presence-sensitive screen, touch-sensitive screen, mouse, keyboard, voice responsive system, video camera, microphone or any other type of device for detecting input from a human or machine. Examples of output are tactile, audio, and video output. Examples of output devices include a presence-sensitive screen, sound card, video graphics adapter card, speaker, cathode ray tube (CRT) monitor, liquid crystal display (LCD), or any other type of device for generating output to a human or machine. For example, IO devices 104 of computing device 26 may include a scanner used to read a format of a particular form. 10 devices 104 of computing device 26 may further include a display device to output a visual representation of the overlay template 34 for approval or editing by an operator.

Advisor device 20 may utilize communication interfaces 106 to communicate with one or more other devices via one or more networks (e.g., network 14 from FIG. 1) by transmitting and/or receiving network signals on the one or more networks. Examples of communication interfaces 106 include a network interface card (e.g. such as an Ethernet card), an optical transceiver, a radio frequency transceiver, or any other type of device that can send and/or receive information, such as through a wired or wireless network. Other examples of communication interfaces 86 may include short wave radios, cellular data radios, wireless Ethernet network radios, as well as universal serial bus (USB) controllers. In some examples, computing device 26 utilizes communication interfaces 106 to wirelessly communicate with external devices, e.g., storage device 2, and/or printing device 28 of wealth management system 10 from FIG. 1.

In the illustrated example of FIG. 6, computing device 26 includes overlay template generation unit 110. In accordance with the disclosed techniques, computing device 26 is configured to analyze a digital version of a particular form and determine positions of one or more queries included on the particular form, e.g., a specific version of a 1040 tax form. For example, computing device 26 may include a scanner configured to scan a physical copy of the form and create a digital image of the particular form. Computing device 26 may then perform optical character recognition (OCR) or otherwise modify the digital image to create a searchable or interactive digital version of the particular form. In other examples, computing device 26 may retrieve a previously created digital version of the particular form from a database or, in some examples, directly from an agency or organization that authored the form, e.g., the IRS.

Regardless of how the digital version of the form is created, overlay template generation unit 110 analyzes the digital version of the form to determine relative positions of each of the queries included on the particular form with respect to the other queries and with respect to borders of the particular form. Based on the calculated positions, overlay template generation unit 110 then generates a digital overlay template as a digital version of a physical overlay instrument. For example, based on a (x, y) position of a first query on the form relative to a given corner of the form, overlay template generation unit 110 may position a box representative of a transparent region at a same position on the digital overlay template. Overlay template generation unit 110 may similarly positioned boxes representative of either transparent regions or opaque regions at the positions of other queries on the form.

In some examples, the overlay template 34 may be displayed for editing or approval by an operator of computing device 26 via one or more of IO devices 104. For example, the operator may remove one or more of the boxes positioned by overlay template generation unit 110 or recharacterize one or more of the boxes as an opaque region instead of a transparent region, or vice versa. In some examples, the operator may add additional boxes as either transparent or opaque regions. In further examples, the operator may add prompts or other text to one or more of the boxes that are representative of the opaque regions.

Once digital overlay template 34 is finalized and/or approved, overlay template generation unit 110 outputs the overlay template 34 for the particular form for storage either in storage device 108 of computing device 26 or at a remote location, e.g., storage device 24 from FIG. 1, accessible by computing device 26 via one of communication interfaces 106. As illustrated in FIG. 6, storage device 108 (or storage device 24 from FIG. 1) may store multiple different overlay templates 34, which may each define a layout of a physical overlay template for a different particular form.

Computing device 26 then sends instructions to printing device 28 from FIG. 1 to manufacture the physical overlay instrument 30 based on digital overlay template 34 via one or communication interfaces 106. The instructions may include instructions to either print or die-cut regions of a sheet of material that correspond to the boxes on digital overlay template 34 that are representative of transparent regions. The instructions may include instructions to either print or not print regions of the sheet of material that correspond to the boxes on digital overlay template 34 that are representative of opaque regions.

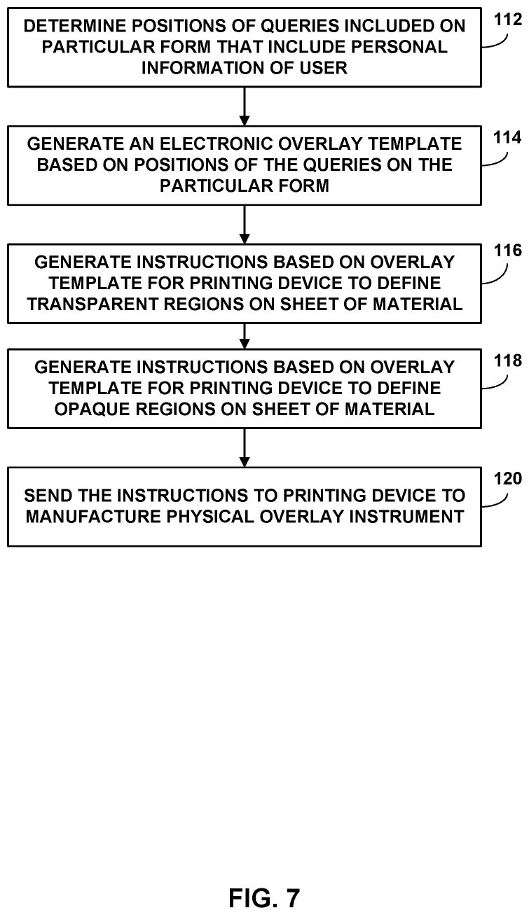

FIG. 7 is a flowchart illustrating an example method of manufacturing a physical overlay instrument, in accordance with the techniques of this disclosure. The example method will be described with respect to computing device 26 and printing device 28 from FIG. 1.

Computing device 26 determines positions of one or more queries included on a particular form 18 that, when filled out by a user 12, include personal information of user 12 (112). As described above with respect to FIG. 6, computing device 26 generates a digital overlay template 34 based on the positions of the one or more queries on the particular form 18 (114). Computing device 26 then generates instructions to be executed by printing device 28 to manufacture physical overlay instrument 30 based on overlay template 34.

Based on the digital overlay template 34, computing device 26 generates instructions for printing device 28 to define one or more transparent regions on the sheet of material such that, when physical overlay instrument 30 is placed over the particular form 18, a first set of the personal information of user 12 is visible through the transparent regions (116). Furthermore, based on overlay template 34, computing device 26 generates instructions for printing device 28 to define one or more opaque regions on the sheet of material such that, when physical overlay instrument 30 is placed over the particular form 18, the opaque regions obscure a second set of the personal information of user 12 from advisor 16 (118). The opaque regions include one or more prompts for advisor 16 to gather additional information from user 12 based on the first set of the personal information of user 12 that is visible through the transparent regions of overlay instrument 30. Computing device 26 then sends the instructions to printing device 28 to manufacture physical overlay instrument 30 upon receipt of a sheet of material having dimensions substantially similar to the particular form 18 (120).

In one example where the sheet of material comprises a transparent material, the instructions generated by computing device 26 cause printing device 28 to define the opaque regions on the sheet of material by printing all regions of the sheet of material that are not designated as transparent regions with an opaque ink, and define the transparent regions on the sheet of material as an absence of the opaque ink. In another example, wherein the sheet of material comprises an opaque material, the instructions generated by computing device 26 cause printing device 28 to define the transparent regions on the sheet of material by die cutting the transparent regions from the sheet of material, and define the one or more opaque regions on the sheet of material as all remaining regions of the sheet of material. In either example, the instructions generated by computing device 26 cause printing device 28 to further define the opaque regions by printing one or more printed regions that include prompts based on the first set of personal information of the user, and define at least one background region that includes all regions of the sheet of material that are not the transparent regions and the printed regions.

In some examples, the instructions generated by computing device 26 may further cause printing device 28 to laminate the sheet of material after the transparent and opaque regions are defined. For example, lamination may be especially useful in the case where the transparent regions are die-cut from the sheet of material. The sheet of material may comprise a flexible plastic film, a rigid plastic sheet, or a laminated sheet of paper or card stock.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A physical overlay instrument comprising:
a sheet of material having dimensions substantially similar to a particular form, wherein the particular form includes one or more queries that, when filled out by a user, include personal information of the user;
one or more transparent regions defined on the sheet of material such that, when the physical overlay instrument is placed over the particular form, a first set of the personal information of the user is visible through the transparent regions; and
one or more opaque regions defined on the sheet of material, wherein the opaque regions include one or more prompts for a third party to gather additional information from the user based on the first set of the personal information of the user that is visible through the transparent regions, and wherein, when the physical overlay instrument is placed over the particular form, the opaque regions obscure a second set of the personal information of the user from the third party.

2. The instrument of claim 1, wherein the first set of personal information includes one or more of dependents information, tax preparer information, retirement account information, interest and dividends information, itemized deduction information, or additional income information.

3. The instrument of claim 1, wherein the second set of personal information comprises confidential information of the user.

4. The instrument of claim 1, wherein the particular form comprises a specific version of a tax form, and wherein the one or more queries comprise one or more lines on the tax form.

5. The instrument of claim 1, wherein the third party comprises a financial advisor, and wherein the prompts comprise questions or statements for the financial advisor to present to the user to gather the additional information from the user.

6. The instrument of claim 1, wherein the sheet of material comprises a one-sided, single sheet of material including:
a first set of the transparent and opaque regions defined at a first set of positions on the sheet of material such that, when placed over a first page of the particular form, a top portion of the physical overlay instrument aligns with a first set of the queries included on the first page of the particular form; and
a second set of the transparent and opaque regions defined at a second set of positions on the sheet of material such that, when placed over a second page of the particular form, a bottom portion of the physical overlay instrument aligns with a second set of the queries included on the second page of the particular form.

7. The instrument of claim 6,
wherein, to align with the first set of queries on the first page of the particular form, the physical overlay instrument is placed over the first page of the particular form in a first orientation; and
wherein, to align with the second set of queries on the second page of the particular form, the physical overlay instrument is placed over the second page of the particular form in a second orientation that is different than the first orientation.

8. The instrument of claim 1, wherein the sheet of material comprises a two-sided, single sheet of material including:
a first set of the transparent and opaque regions defined at a first set of positions on the sheet of material such that, when placed over a first page of the particular form, a first side of the physical overlay instrument aligns with a first set of the queries included on the first page of the particular form; and
a second set of the transparent and opaque regions defined at a second set of positions on the sheet of material such that, when placed over a second page of the particular form, a second side of the physical overlay instrument aligns with a second set of queries included on the second page of the particular form.

9. The instrument of claim 1, wherein the sheet of material comprises a transparent material, and wherein the one or more transparent regions are defined on the sheet of material as an absence of an opaque ink applied to all other regions of the sheet of material.

10. The instrument of claim 1, wherein the sheet of material comprises an opaque material, and wherein the one or more transparent regions comprise die cuts from the sheet of material.

11. The instrument of claim 1, wherein the one or more opaque regions comprise all regions of the sheet of material that are not the transparent regions.

12. The instrument of claim 1, wherein the opaque regions comprise:
one or more printed regions that include the one or more prompts based on the first set of personal information of the user; and
a background region that includes all regions of the sheet of material that are not the transparent regions and the printed regions.

13. The instrument of claim 1, wherein the sheet of material comprises one of a flexible plastic film or a rigid plastic sheet.

14. The instrument of claim 1, wherein the sheet of material comprises a laminated sheet of paper or card stock.

15-21. (canceled)

22. A system comprising:
a physical overlay instrument comprising:
a sheet of material having dimensions substantially similar to a particular form, wherein the particular form includes one or more queries that, when filled out by a user, include personal information of the user;
one or more transparent regions defined on the sheet of material such that, when the physical overlay instrument is placed over the particular form, a first set of the personal information of the user is visible through the transparent regions; and
one or more opaque regions defined on the sheet of material, wherein the opaque regions include one or more prompts for a third party to gather additional information from the user based on the first set of the personal information of the user that is visible through the transparent regions, and wherein, when the physical overlay instrument is placed over the particular form, the opaque regions obscure a second set of the personal information of the user from the third party; and
a computing device of the third party comprising a memory and one or more processors configured to execute an application comprising instructions to present user profile data for the user via a display device of the computing device of the third party, wherein the one or more processors are configured to receive input from the third party to change the user profile data for the user based on the additional information gathered from the user in response to the prompts included on the opaque regions defined on the sheet of material for the physical overlay instrument.

23. The system of claim 22, wherein the one or more processors of the computing device of the third party are configured to execute an application comprising instructions to present a digital overlay user guide associated with the physical overlay instrument, wherein the one or more processors are configured to, based on the additional information gathered from the user in response to the prompts included on the opaque regions defined on the sheet of material for the physical overlay instrument, receive input from the third party to at least one of select an action item or access resources recommended by the digital overlay user guide.
